(19) United States
(12) Patent Application Publication
(10) Pub. No.: US 2022/0002571 A1
(43) Pub. Date: Jan. 6, 2022

(54) HYDROPHILIC COATING COMPOSITION FOR DOUBLE-LAYER COATING AND HYDROPHILIC COATING METHOD USING SAME

(71) Applicant: Noanix Corporation, Cheongju-si (KR)

(72) Inventor: Hyung Joon CHOI, Cheongju-si (KR)

(21) Appl. No.: 16/941,185

(22) Filed: Jul. 28, 2020

(30) Foreign Application Priority Data
Jul. 1, 2020 (KR) 10-2020-0080984

(51) Int. Cl. C09D 105/00; C09D 133/08

(52) U.S. Cl. CPC C09D 105/00; C09D 133/08

(57) ABSTRACT

This application relates to a composition for hydrophilic coating and a hydrophilic coating method using the same. The composition may include a first coating solution comprising an acrylic compound, a second coating solution comprising a polysaccharide and a crosslinking agent. The hydrophilic coating can form a coating, which is highly hydrophilic, has great biocompatibility, and is thin and flexible. Therefore, when the composition is coated on an invasive medical device, lubricity can be greatly improved, and thus there is an advantage of preventing damage to the human body, such as injury, tissue wear, and the like.

### CROSS REFERENCE TO RELATED APPLICATION

The present application claims priority based on Korean Patent Application No. 10-2020-0080984, filed on Jul. 1, 2020, the entire content of which is incorporated herein for all purposes by this reference.

### BACKGROUND

### 1. Field

The described technology relates to a composition for hydrophilic coating and a hydrophilic coating method using the same.

### 2. Description of the Related Technology

Recently, medical devices for use in surgical procedures have been actively developed. Examples thereof include a variety of vascular catheters that may be used in treatment of the circulatory system, such as aortic surgery, etc., and stents that strengthen arterial walls and prevent occlusion after angioplasty. Moreover, an extended list of such devices includes heart valves, artificial pacemakers and orthopedic implants.

The devices described above are often composed of plastics and metals that exist for a long time in the human body. They generally have very different surface area characteristics from hydrophilic, slippery and biocompatible human organs. These non-compatible invasive devices are regarded as foreign objects by the body's defense system and thus often cause inflammation and thrombosis.

Lubricity is equally important for medical devices that need to be inserted and moved through body tissue. Most metals and plastics are inadequately lubricious to body tissue, so mechanical friction occurs when the device passes through tissue. The surfaces of devices designed and manufactured using these materials need to be made hydrophilic, slippery and biocompatible through appropriate coating.

With the goal of solving the above problems, the present inventors have developed a hydrophilic coating solution having lubricity, wear resistance and biocompatibility and have ascertained that the coating solution is suitable for coating vascular catheters, guide wires and other medical devices, and may be applied to a wide range of polymer and metal substrates.

### SUMMARY

Accordingly, an objective of the present invention is to provide a composition for hydrophilic coating including a first coating solution including an acrylic compound, a second coating solution including a polysaccharide, and a crosslinking agent.

Another objective of the present invention is to provide a hydrophilic coating method using the composition for hydrophilic coating.

Still another objective of the present invention is to provide a substrate coated through the above method.

In order to accomplish the above objectives, the present invention provides a composition for hydrophilic coating, including: a first coating solution including an acrylic compound; a second coating solution including a polysaccharide; and a crosslinking agent.

In an embodiment of the present invention, the first coating solution may be bound to a substrate, and the second coating solution may be bound to the first coating solution, which is bound to the substrate, by the crosslinking agent.

In an embodiment of the present invention, the composition may be biocompatible.

In an embodiment of the present invention, the acrylic compound may be an acrylate polymer.

In an embodiment of the present invention, the polysaccharide may be hyaluronic acid.

In an embodiment of the present invention, the crosslinking agent may be a polyaziridine-based crosslinking agent or a polyisocyanate-based crosslinking agent.

In an embodiment of the present invention, the second coating solution may further include polyether polyurethane.

In an embodiment of the present invention, the weight ratio of polysaccharide to polyether polyurethane may be 10:0.5-2.

In addition, the present invention provides a hydrophilic coating method, including: a) coating the surface of a substrate with a first coating solution; b) drying the substrate coated in step a); c) coating the substrate dried in step b) with a second coating solution; and d) drying the second coating solution applied in step c).

In addition, the present invention provides a substrate subjected to hydrophilic coating through the above method.

According to the present invention, a coating solution is capable of forming a coating, which is highly hydrophilic, has great biocompatibility, and is thin and flexible. Therefore, when the coating solution is applied to an invasive medical device, lubricity can be greatly improved, and thus there is an advantage of preventing damage to the human body, such as injury, tissue wear, and the like.

### BRIEF DESCRIPTION OF DRAWINGS

FIG. 1A and FIG. 1B show the results of comparison of frictional force depending on the presence or absence of an additive in the second coating solution.

FIG. 2A and FIG. 2B show the results of comparison of frictional force before and after coating using the hydrophilic coating solution of the present invention.

### DETAILED DESCRIPTION

An aspect of the present invention pertains to a composition for hydrophilic coating including a first coating solution including an acrylic compound, a second coating solution including a polysaccharide, and a crosslinking agent.

In the present invention, the acrylic compound is a concept that includes a resin (polymer) including, as repeating unit, a monomer of acrylic acid, acrylate, methacrylic acid and derivatives thereof, and may be a homopolymer or a copolymer composed of two or more monomers.

In the present invention, the polysaccharide is a polymer carbohydrate molecule composed of a long chain of monosaccharide units that are bound through glycoside bonding.

As used herein, the term “hydrophilic” means that droplets do not easily form beads on the surface of a hydrophilic material, and tend to spread easily on the surface thereof at a contact angle of less than 45°.

The composition for hydrophilic coating of the present invention may include one or more additives typically useful in coating formulations, for example, surfactants, preservatives, viscosity modifiers, pigments, dyes and other additives known to those skilled in the art.

In the present invention, the first coating solution is bound to the substrate, and the second coating solution is bound to the first coating solution, which is bound to the substrate, by the crosslinking agent.

The second coating solution, which is hydrophilic in the coating solution of the present invention, provides lubricity to the coated medical device when coming into contact with an aqueous medium. The first coating solution is located in the intermediate layer between the hydrophilic second coating solution and the medical device surface, and adheres well to the medical device substrate.

The crosslinking agent compound is used to bind the second coating solution polymer to the first coating solution polymer. Thus, the hydrophilic polymer in the second coating solution is chemically attached to the first coating solution layer. The cured first coating solution absorbs a very small amount of water, so the coated medical device is capable of maintaining adhesion when coming into contact with an aqueous medium. Simultaneously, a second coating, fixed to a first coating, may provide lubricity.

In the present invention, the crosslinking agent may be applied without limitation, so long as it is a compound capable of binding a layer coated with the first coating solution (hereinafter referred to as a first coating layer) and a layer coated with the second coating solution (hereinafter referred to as a second coating layer) to each other. Preferably, the crosslinking agent is an aziridine-based crosslinking agent or an isocyanate-based crosslinking agent, but is not limited thereto. Moreover, the crosslinking agent may be used by being added to the first coating solution, or may be used separately from the first coating solution.

In the present invention, the substrate is an object onto which the hydrophilic coating solution is applied. Although there is no particular limitation thereon, the substrate is preferably an invasive medical device, and typical examples of such a medical device include, but are not limited to, a catheter, a balloon catheter, a guide wire, an endotracheal tube, an implant, and the like.

In the present invention, the composition may be biocompatible.

Biocompatibility refers to a property whereby administration or application of a material to a living body does not cause a disorder or side effect in the living body.

In the present invention, the acrylic compound may be an acrylate polymer, and examples of the monomer of the polymer may include, but are not limited to, methyl acrylate, ethyl acrylate, butyl acrylate, cyclohexyl acrylate, hexyl acrylate, 2-ethylhexyl acrylate, stearyl acrylate, and the like.

In the present invention, the polysaccharide may be hyaluronic acid, but is not limited thereto.

In the present invention, the crosslinking agent may be a polyaziridine-based crosslinking agent or a polyisocyanate-based crosslinking agent, but is not limited thereto.

In the present invention, the second coating solution may further include polyether polyurethane, and the polyether polyurethane included in the second coating solution may be the same as the polyether polyurethane included in the first coating solution, or may be another polyether polyurethane series.

In the present invention, the weight ratio of polysaccharide to polyether polyurethane may be 10:0.5-2, preferably 10:0.5-1.5, and most preferably 10:1. When the substrate is coated with the coating solution mixed at the above ratio, a coating having low frictional force and high durability may be provided.

Another aspect of the present invention pertains to a hydrophilic coating method including a) coating the surface of a substrate with a first coating solution, b) drying the substrate coated in step a), c) coating the substrate dried in step b) with a second coating solution and d) drying the second coating solution applied in step c).

The coating may be formed through a coating process typically useful in the art using the hydrophilic coating solution of the present invention. Preferably, the coating process is dip coating, but is not limited thereto.

Still another aspect of the present invention pertains to a substrate subjected to hydrophilic coating through the above method. The coating solution of the present invention is capable of forming a coating, which has high hydrophilicity and great biocompatibility and is thin and flexible, and the coated substrate is greatly improved in lubricity and does not cause damage to the human body, such as injury, tissue wear, etc.

A better understanding of the present invention will be given through the following examples. However, these examples are merely set forth to illustrate the present invention, and are not to be construed as limiting the scope of the present invention.

### EXAMPLE 1

### Preparation of Coating Solution

Preparation of First Coating Solution

5 g of an ethyl acrylate polymer was mixed with 1 L of a solvent composed of toluene and isopropyl alcohol (IPA) at 5:5 wt % in a bottle. Then, 3 g of HDB-LV (polyisocyanate-based crosslinking agent) was added and dissolved therein, after which 0.7 g of a HD-100 (10% in PMA, polyaziridine-based crosslinking agent) solution was added and dissolved therein, thus preparing a first coating solution added with the crosslinking agent.

Preparation of Second Coating Solution

50 g of a hyaluronic acid powder was placed in a 1 L bottle, 500 ml of ethanol (EtOH) was placed in the bottle, and stirring was performed so that the hyaluronic acid powder was dispersed well. Then, while 500 ml of distilled water (DW) was slowly added thereto, stirring was performed until the hyaluronic acid powder was dissolved. Complete dissolution of the hyaluronic acid powder was confirmed, and stirring was then performed until air bubbles were removed, after which 5 g of 5604A as a polyether polyurethane-based compound was added and stirred until dissolved, thus preparing a second coating solution.

### EXAMPLE 2

### Coating of Substrate Using Hydrophilic Coating Solution

First, a coating object was washed with a mixed solution of IPA (isopropyl alcohol) and distilled water and then dried. Thereafter, the coating object was dipped in the first coating solution prepared in the method of Example 1, coated, and then dried in an oven (60° C., 10 min). The object thus obtained was cooled at room temperature for about 5 to 10 min, dipped in the second coating solution prepared in the method of Example 1, coated, and then dried in an oven (60° C., 120 min). Thereafter, the object thus coated was completely immersed in distilled water for washing, allowed to stand for 20 min, washed again with distilled water, and then dried.

### EXAMPLE 3

### Observation of Increase in Lubricity of Second Coating Solution Added with Additive

In order to evaluate the improvement in the coating solution when the polyether polyurethane additive was included in the second coating solution, a frictional force test was performed.

The test principle was as follows. The upper portion of a catheter sample coated as in the method of Example 2 was fixed to a clamp above the water tank in an apparatus, after which the sample was dragged at a predetermined speed, and the frictional force was measured 10 times using a frictional force sensor in order to determine surface smoothness.

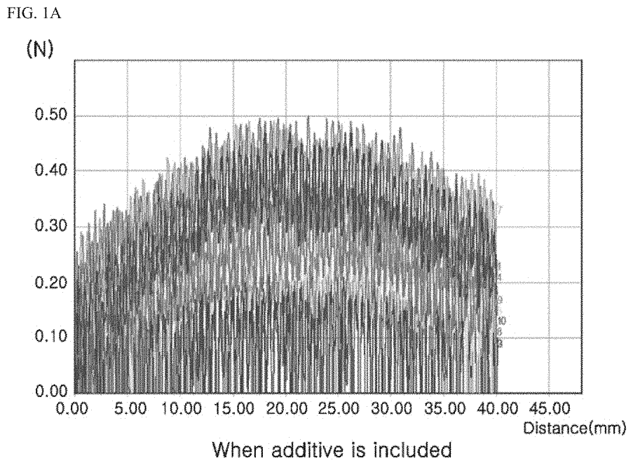

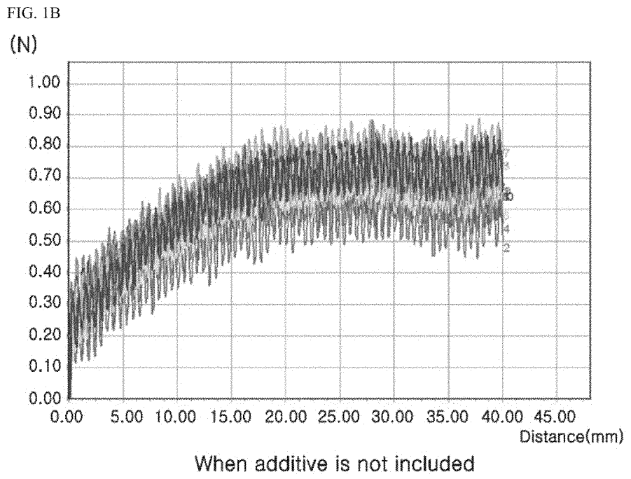

As shown in FIG. 1A and FIG. 1B, the frictional force of the sample added with the additive was measured to be significantly low. Therefore, when polyether polyurethane was included as the additive, it was confirmed that the surface smoothness of the substrate was greatly increased through a synergistic effect thereof with hyaluronic acid.

### EXAMPLE 4

### Comparison of Frictional Force of Substrate Before and After Coating

In order to evaluate the surface coating effect before and after coating, the surface of a sample was subjected to a frictional force test in the same manner as in Example 3.

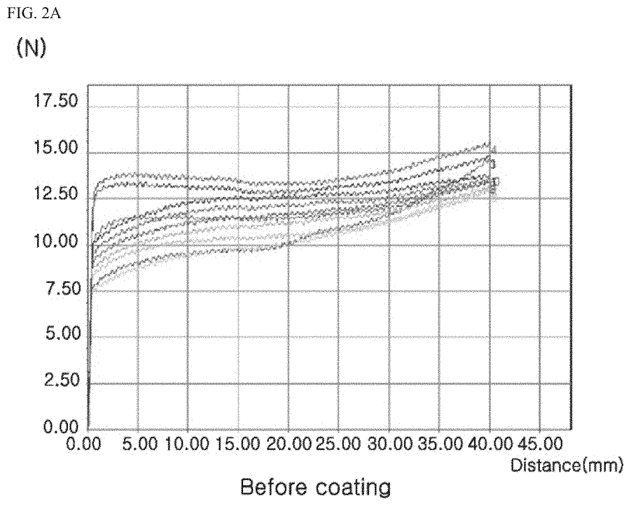

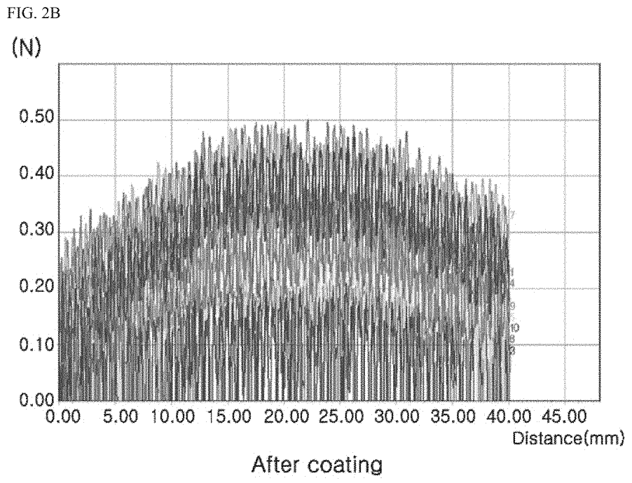

As shown in FIG. 2A and FIG. 2B, the surface frictional force after coating treatment was much lower than the surface frictional force before coating treatment, indicating that the surface smoothness of the substrate after coating is remarkably increased.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A composition for hydrophilic coating, comprising:
a first coating solution comprising an acrylic compound;
a second coating solution comprising a polysaccharide; and
a crosslinking agent.

2. The composition for hydrophilic coating of claim 1, wherein the first coating solution is bound to a substrate, and the second coating solution is bound to the first coating solution, which is bound to the substrate, by the crosslinking agent.

3. The composition for hydrophilic coating of claim 1, wherein the composition is biocompatible.

4. The composition for hydrophilic coating of claim 1, wherein the acrylic compound is an acrylate polymer.

5. The composition for hydrophilic coating of claim 1, wherein the polysaccharide is hyaluronic acid.

6. The composition for hydrophilic coating of claim 1, wherein the crosslinking agent is a polyaziridine-based crosslinking agent or a polyisocyanate-based crosslinking agent.

7. The composition for hydrophilic coating of claim 1, wherein the second coating solution further comprises polyether polyurethane.

8. The composition for hydrophilic coating of claim 7, wherein a weight ratio of the polysaccharide to the polyether polyurethane is 10:0.5-2.

9. A hydrophilic coating method, comprising:
coating a surface of a substrate with a first coating solution;
drying the substrate coated with the first coating solution;
coating the dried substrate with a second coating solution; and
drying the second coating solution coated on the dried substrate.

10. A substrate subjected to hydrophilic coating through the method of claim 9.
